(19) United States
(12) Patent Application Publication
(10) Pub. No.: US 2020/0005541 A1
(43) Pub. Date: Jan. 2, 2020

(54) MULTI-PLAYER VR GAME SYSTEM WITH SPECTATOR PARTICIPATION

(71) Applicant: Unchartedvr Inc., San Rafael, CA (US)

(72) Inventor: Jim Preston, San Rafael, CA (US)

(21) Appl. No.: 16/263,687

(22) Filed: Jan. 31, 2019

Related U.S. Application Data
(60) Provisional application No. 62/624,756, filed on Jan. 31, 2018.
(60) Provisional application No. 62/624,754, filed on Jan. 31, 2018.

(51) Int. Cl. G06T 19/00; G02B 27/01; G06F 3/0481; A63F 13/792; A63F 13/352

(52) U.S. Cl. CPC G06T 19/006; G02B 27/017; A63F 13/352; G06T 19/003; A63F 13/792; G06F 3/04815

(57) ABSTRACT

A “porous interactive” VR system provides a multiplayer VR gameplay experience on a physical game space, such as a stage, platform, or set in a commercial venue. Multiple players move about on the game space and participate in the shared VR gameplay experience. Feeds given to the players themselves, through their headsets, are also directed to the Internet and/or to a secondary participant space that is set apart from the game space. This support for remote viewers enables secondary participants to visualize and hear the same VR experience being experienced in real time by active players. In one embodiment, an onlooker space is also provided, set apart from both the game space and the secondary participant space. A 2D video digital feed to a display, visible to the onlookers, provides the onlookers with a 2D representation of gameplay occurring within the game space.

### CROSS-REFERENCE TO RELATED APPLICATIONS

This application claims the benefit of U.S. Provisional Patent Application Nos. 62/624,754 and 62/624,756, respectively entitled “Porous Interactive Multi-Player VR Game System” and “Multi-Player VR Game System with Network Participation,” both filed on Jan. 31, 2018, and both of which are herein incorporated by reference for all purposes.

This application is also related to the following co-pending U.S. patent applications, many of which have a common assignee and common inventors, and all of which are herein incorporated by reference for all purposes.

| | FILING | |
|---|---|---|
| SER. NO. | DATE | TITLE |
| 15/783,664 | Oct. 13, 2017 | MODULAR SOLUTION FOR DELIVERING A VIRTUAL |
| (DVR.0101) | | REALITY ATTRACTION |
| 15/828,198 | Nov. 30, 2017 | METHOD FOR GRID-BASED VIRTUAL REALITY |
| (DVR.0101-C1) | | ATTRACTION |
| 15/828,257 | Nov. 30, 2017 | GRID-BASED VIRTUAL REALITY ATTRACTION SYSTEM |
| (DVR.0101-C2) | | |
| 15/828,276 | Nov. 30, 2017 | SMART PROPS FOR GRID-BASED VIRTUAL REALITY |
| (DVR.0101-C3) | | ATTRACTION |
| 15/828,294 | Nov. 30, 2017 | MULTIPLE PARTICIPANT VIRTUAL REALITY ATTRACTION |
| (DVR.0101-C4) | | |
| 15/828,307 | Nov. 30, 2017 | GRID-BASED VIRTUAL REALITY SYSTEM FOR |
| (DVR.0101-C5) | | COMMUNICATION WITH EXTERNAL AUDIENCE |
| 62/571,638 | Oct. 12, 2017 | MODULAR SOLUTION FOR DELIVERING A VIRTUAL |
| (DVR.0102) | | REALITY ATTRACTION |
| 15/873,523 | Jan. 17, 2018 | METHOD FOR AUGMENTING A VIRTUAL REALITY |
| (DVR.0103) | | EXPERIENCE |
| 15/873,553 | Jan. 17, 2018 | METHOD FOR GRID-BASED VIRTUAL REALITY |
| (DVR.0104) | | ATTRACTION SYSTEM |
| 15/873,589 | Jan. 17, 2018 | MODULAR PROPS FOR A GRID-BASED VIRTUAL REALITY |
| (DVR.0105) | | ATTRACTION |
| 62/618,386 | Jan. 17, 2018 | CONTROL OF PHYSICAL OBJECTS IN A VIRTUAL WORLD |
| (DVR.0106) | | |
| 62/618,395 | Jan. 17, 2018 | CONTROL OF PHYSICAL OBJECTS VIA VIRTUAL |
| (DVR.0107) | | EXPERIENCE TRIGGERS |
| 62/618,405 | Jan. 17, 2018 | VIRTUAL EXPERIENCE MONITORING MECHANISM |
| (DVR.0108) | | |
| 62/618,416 | Jan. 17, 2018 | VIRTUAL EXPERIENCE CONTROL MECHANISM |
| (DVR.0109) | | |
| 62/618,030 | Jan. 16, 2018 | REGISTERING AND CALIBRATING PHYSICAL PROPS USED |
| (DVR.0110) | | IN A VR WORLD |
| 62/618,038 | Jan. 16, 2018 | VR SYSTEM FOR TRACKING THREE TYPES OF PHYSICAL |
| (DVR.0111) | | COMPONENTS |
| 62/614,467 | Jan. 7, 2018 | HYBRID HAND TRACKING OF PARTICIPANTS TO CREATE |
| (DVR.0115) | | BELIEVABLE DIGITAL AVATARS |
| 62/614,469 | Jan. 7, 2018 | HYBRID HAND AND FINGER MOVEMENT BLENDING TO |
| (DVR.0116) | | CREATE BELIEVABLE AVATARS |
| 62/620,378 | Jan. 22, 2018 | SAFE SPACE MECHANISM FOR VIRTUAL REALITY |
| (DVR.0117) | | GAMEPLAY |

### BACKGROUND OF THE INVENTION

### Field of the Invention

This invention relates in general to the field of virtual reality attractions, and more particularly to virtual reality attractions that blend physical elements with VR representations.

### BRIEF DESCRIPTION OF THE DRAWINGS

These and other objects, features, and advantages of the present invention will become better understood with regard to the following description, and accompanying drawings where:

FIG. 1 illustrates one embodiment of a modular stage with a first arrangement of stage accessories to augment the illusion of a first VR experience;

FIG. 2 illustrates the modular stage of FIG. 1 with a second arrangement of stage accessories to augment the illusion of a second VR experience;

FIG. 3A illustrates the modular stage of FIG. 1 illustrating a labeled grid of separable modular stage sections, each having a plurality of peg holes for fixing the stage accessories to the modular stage;

FIG. 3B is an enlarged view of a separable modular stage section, showing a labeled secondary grid of peg holes in the modular stage section;

FIG. 4 is a perspective view of a wall equipped with pegs positioned over holes in a portion of the modular stage;

FIG. 5 illustrates a building facade accessory mounted on a modular stage;

FIG. 6 illustrates a VR representation of the building façade, embellished with an appearance of log siding and a tiled roof in a wooded surrounding;

FIG. 7 illustrates a VR participant holding a flashlight prop while pushing open a door of the building facade;

FIG. 8 illustrates a VR representation of an aged industrial doorway, with a flashlight-illuminated area that corresponds to the direction in which the flashlight prop is pointing;

FIG. 9 illustrates a VR participant walking over a wooden plank prop positioned on a modular stage platform;

FIG. 10 illustrates a corresponding VR representation of the wooden plank positioned over a deep gap separating two buildings;

FIG. 11 illustrates an elevator simulator on the modular stage;

FIG. 12 illustrates a corresponding VR representation of a VR elevator;

FIG. 13 illustrates a VR participant holding a firearm prop;

FIG. 14 illustrates a corresponding VR representation provided to the VR participant as he holds the firearm prop;

FIG. 15 illustrates a game space proximate to a secondary participant space proximate to an onlooker space;

FIG. 16 illustrates a VR world that conforms to players and objects in the game space.

FIG. 17 illustrates a remote viewer web interface that enables remote viewers to select a player, pay for power-ups, see and hear the same sights and sounds seen and heard by a selected player, speak to the selected player, and input commands to alter aspects of the VR world or of the gameplay.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope supported by this disclosure.

The present invention will now be described with reference to the attached Figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

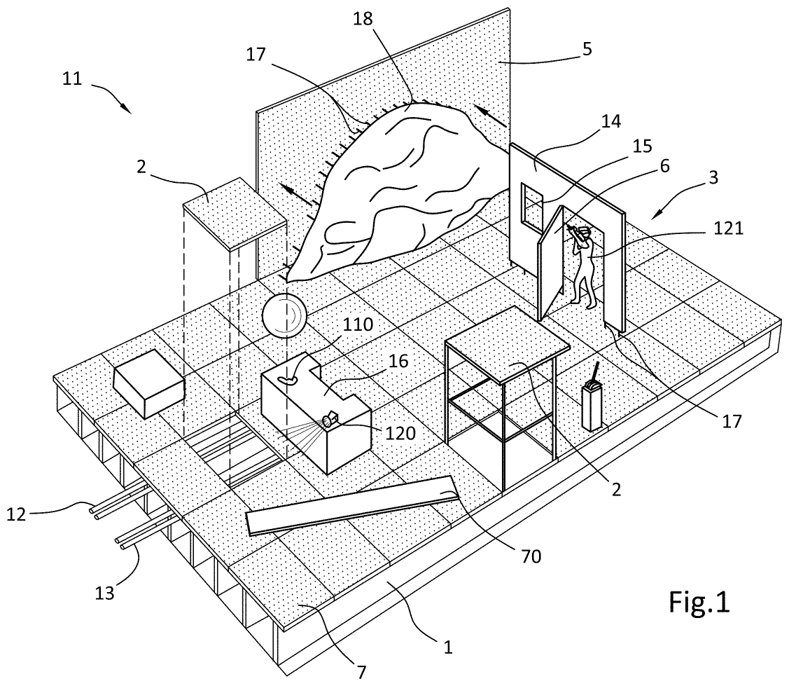

FIG. 1 illustrates one embodiment of a modular stage 1 with a first grid aligned arrangement 11 of stage accessories 14, 16, 18, 70, 110, 120 to augment the illusion of a first VR experience/representation. The stage accessories 14, 16, 18, 70, 110, 120 are provided as part of a VR stage kit 11. The stage accessories 14, 16, 18, 70, 110, 120 are assembled to the stage 1 according a plurality of stage plans or arrangements that correspond to a plurality of VR representations (aka “VR worlds”) provided in a VR attraction. The stage accessories 14, 16, 18, 70, 110, 120 include set pieces and props. For example, FIG. 1 illustrates a facade 14 with a window 15 and door 6, a rock 18 attached to a perimeter wall 5, a flashlight prop 120 and a firearm prop 110 resting on a desk 16, and a plank 70 on resting on a floor of a modular stage platform 3. The accessories 14, 16, 18, 70, 110, 120 give virtual reality participants sensory feedback that augments a virtual reality representation. Some of the accessories 14, 16, 18, 70, 110, 120 may comprise fittings 17 (such as pegs) to mount them to the modular stage platform 3.

A modular stage 1 comprises a plurality of separable modular stage sections 2 designed to fit and cooperate with each other for ease of assembly to form the stage 1. The modular stage 1 and its kit 11 of stage accessories 14, 16, 18, 70, 110, 120 are configurable to fill a discrete set of spatial areas—for example, 10 meters by 20 meters and 15 meters by 15 meters—that might be found in a mall, theater, or other retail space. Different spatial representations of a VR world are created to fit one or more of these areas and correspond to one or more stage plans or arrangements of accessories 14, 16, 18, 70, 110, 120 on the stage 1.

In one embodiment, the modular stage 1 comprises a commercially available stage kit (not to be confused with the accessory kit 11 described herein). Discretely positioned (and preferably regularly spaced) accessory mounts 7 are either provided with, or incorporated into, the stage 1. In one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

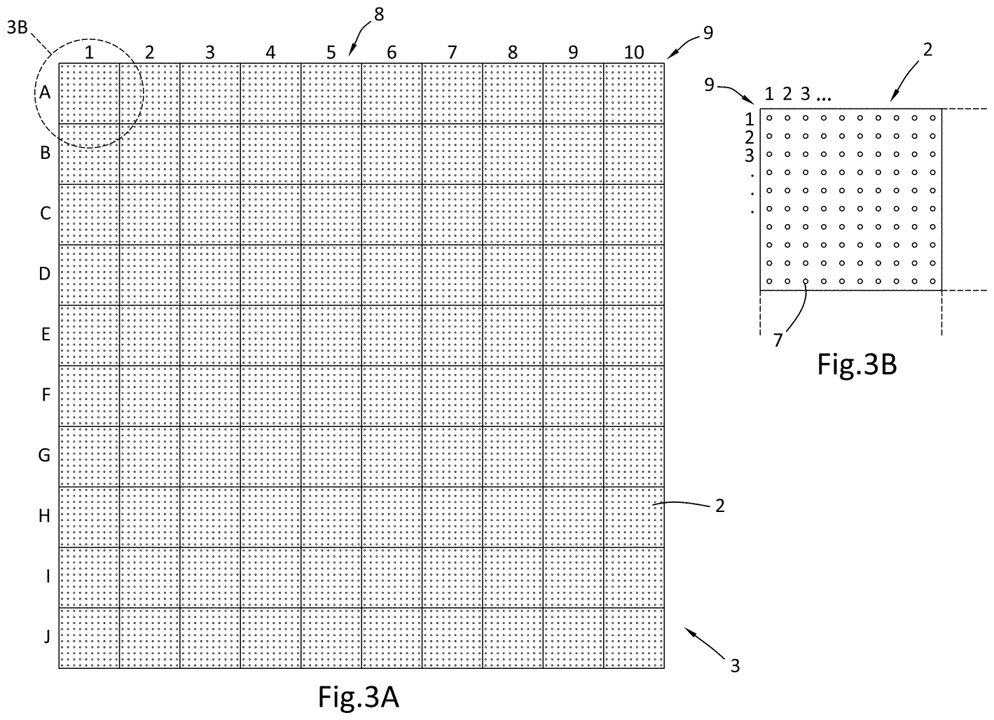

FIG. 3A illustrates a modular stage platform 3 made up of separable squares or platform sections 2. For example, each square 2 may be 1 m×1 m. FIG. 3B illustrates each square 2 as providing multiple aligned rows of accessory mounts 7 in the form of holes that are spaced 1 decimeter (for example) apart from each nearest accessory mount 7. The squares 2 are adapted to be connected to each other to create platforms 3 of different rectilinear dimensions. This enables the modular stage 1 to fit a wide range of conventional leasable commercial spaces.

The accessory mounts 7 are placed at preselected coordinates in a grid-like fashion in order to provide discrete places, readily and accurately represented in a VR world, for the mounting of the stage accessories 14, 16, 18, 70, 110, 120. In one practical embodiment, the accessory mounts 7 are peg holes that are regularly spaced and configured for receiving accessories that have cooperating pegs. In this application, the term “peg” is used in a broad sense to encompass large structures as well as small structures. The peg holes 7 may be round, square, dimensioned to receive a dimensional board, or some other shape. The peg holes 7 are defined by a surrounding structure that, in conjunction with cooperating fittings or mounts 17 (e.g., pegs), provide sufficient strength to fix and stabilize any mounted accessory 14, 16, 18, 70, 110, 120. In an alternative embodiment, the stage platform 3 is modified to incorporate pegs 17 for receiving accessories 14, 16, 18, 70, 110, 120 with cooperating holes 7.

Any suitable substitute for a peg-and-hole system would also fall within the scope of the present invention, including mounts in the form of seats, sockets, interconnectors, fasteners, couplers, couplings, clamps, hand-operated quick-release clasps, ties, pins, snaps, links, and the like. The scope of the invention also includes any arrangement of female and male parts that attach one object to another, provided that they facilitate quick assembly and disassembly.

Collectively, the peg holes or other accessory mounts 7 of the modular stage platform 3 are aligned within rectilinear rows and columns, forming a grid or regular pattern 8. In one embodiment, the stage sides have a primary set of alphanumeric markings 9, respectively, to identify each square 2 in the modular stage. In the 1 meter by 1 meter square embodiment, this grid density provides a 1 meter by 1 meter level of resolution. Each square or alternatively dimensioned platform section 2 may also be labeled with its own secondary set of alphanumeric markings 9, to identify each accessory mount 7 in the square or section 2. In the 100-holes per square embodiment, this grid density provides a 1-decimeter by 1-decimeter level of resolution. The invention is, of course, not limited to these square dimensions or grid densities.

The assembly of the accessories 14, 16, 18, 70, 110, 120 to the modular stage platform 3 makes use of the positioning grid 8. For example, as noted above, many of the accessories 14, 16, 18, 70, 110, 120 are arranged with fittings 17 (such as pegs) to mount them to the modular stage platform 3 at particular stage platform coordinates. The accessory mounts 7 cooperate with the fittings 17 to secure the accessories 14, 16, 18, 70, 110, 120 to the platform 3. This aids in fast and accurate alignment with objects in virtual reality.

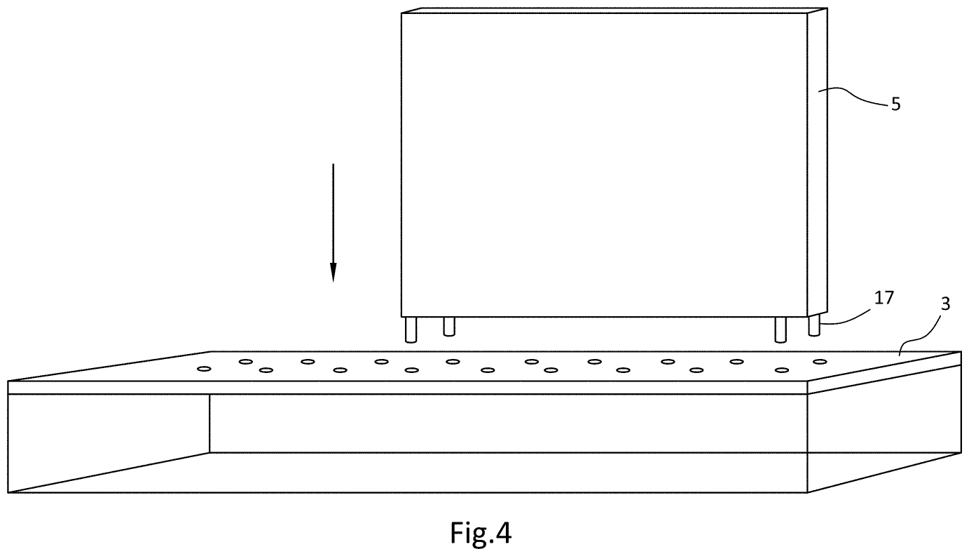

FIG. 4 illustrates this ease of assembly and disassembly by showing a wall section 5 equipped with fittings 17 in the form of pegs positioned over peg holes 7 in a portion of the modular stage platform 3. Assembling the wall section 5 may be as simple as identifying the correct holes on the grid 8 using the alphanumeric markings 9 labeling the grid 8, and inserting the pegs into the holes 7. Disassembling the wall section 5 may be as simple as lifting it from the stage 3. Quick-release clamps or connectors (e.g., clamps or connectors that do not require tools to operate) may optionally be employed, because they would only modestly increase the amount of time needed to assemble and disassemble the accessories 14, 16, 18, 70, 110, 120.

Parts may be added to or subtracted from the kit 11 to create new configurations. In one embodiment, the modular stage 1 includes perimeter walls 5 that are also covered in a labeled grid pattern 8, facilitating fastening of objects to the walls 5 in precise, discrete, exact, and vertically-aligned locations. A primary modular stage accessory 5, such as an interior wall, may include its own labeled grid and pattern of accessory mounts (not shown) so that one or more secondary modular stage accessories 14, 16, 18, 70, 110, 120 can be accurately mounted to the primary stage accessory 5.

The grid-based approach described above is preferable to several alternative approaches to aligning a virtual world with a physical construction. One common alternative approach is to create a permanent “one-up” VR attraction that has not been designed in a modular fashion. It is not practical to update such attractions, limiting their ability to bring in and appeal to repeat customers. Another approach would require that video sensors and/or other sensors be used to determine the location and orientation of each fixed, stationary modular stage accessory 14, 16, 18. This approach in practice would provide a less accurate and/or reliable means of aligning the virtual and physical worlds than this invention's approach, in which the objects of the VR representation and the physical world are positioned at predetermined coordinates or grid points that select prepositioned accessory mounts 7. Another alternative would involve arranging accessories 14, 16, 18, 70, 110, 120 on to the stage platform 3 at specified coordinates without the benefit of a grid 8 or a patterned arrangement of peg holes or the like. A disadvantage of this approach is that it takes longer to assemble the stage, and with greater chance of error. Another disadvantage of this approach is that stage assemblers cannot assemble a stage as precisely and quickly, this way, as they would with the grid-based approach. The result is that the physical and virtual worlds may not align as precisely as they would with the grid-based approach.

As noted above, in one embodiment, the stage 1 is elevated above the ground, enabling signal lines 12 and power lines 13 to pass underneath the platform 3 and through openings in the platform 3 (e.g., the peg holes 7) to service the accessories 14, 16, 18, 70, 110, 120 mounted on the stage 1.

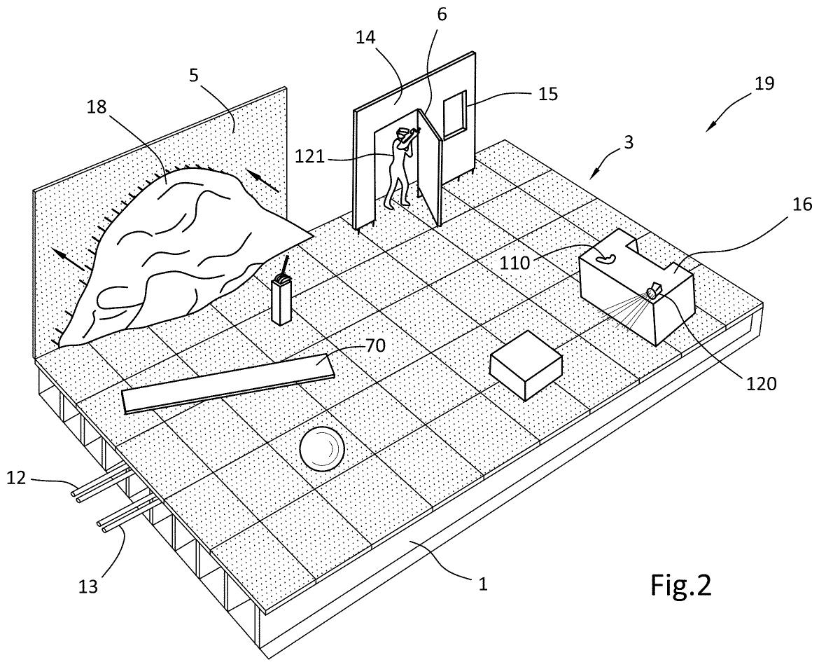

FIG. 2 illustrates the modular stage 1 of FIG. 1 with a second stage plan or arrangement 19 of stage accessories 14, 16, 18, 70, 110, 120 to augment the illusion of a second VR representation. FIGS. 1 and 2 illustrate the speed and convenience with which accessories 14, 16, 18, 70, 110, 120 can be accurately re-arranged on the stage 1 to correspond to different VR representations, with an ease that resembles rearranging Lego® blocks or placing one's ships at the start of a new Battleship® game. Advantageously, this makes it practical for proprietors to engage local customers with new experiences, keeping them coming back again and again.

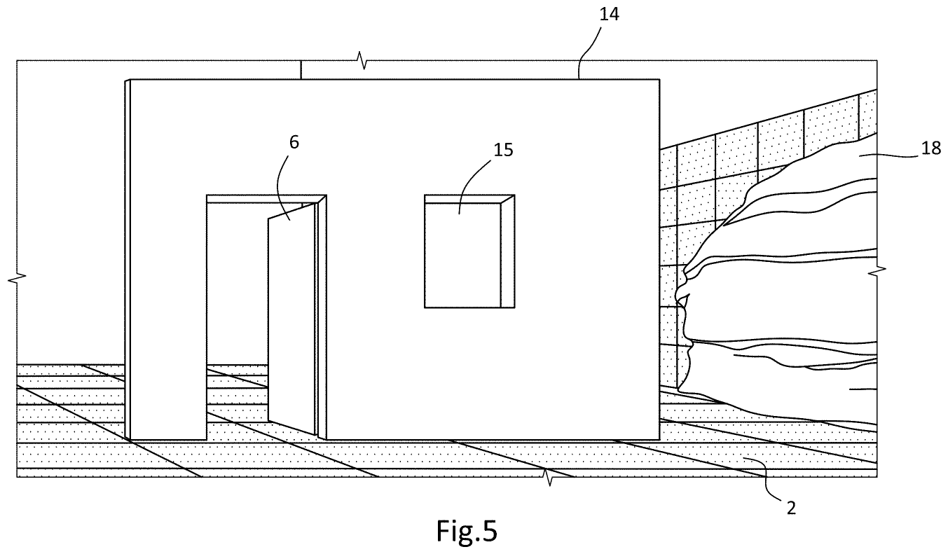

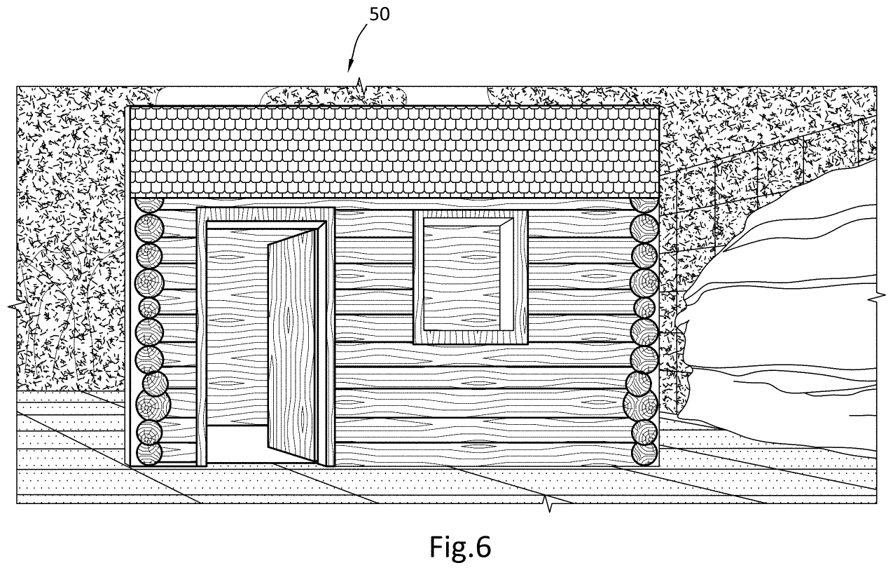

FIG. 5 illustrates a building facade 14 mounted on a modular stage. The building façade 14 comprises a door 6 and window 15 and has simple, flat dimensions. A 3D polystyrene rendering of a rock 18 has the contour of a large rock or boulder and is coated with material like sand and simulated moss to give it a rock-like tactile sensation. FIG. 6 illustrates a VR representation 50 of the building facade 14, embellished with an appearance of log siding and a tiled roof in a wooded surrounding.

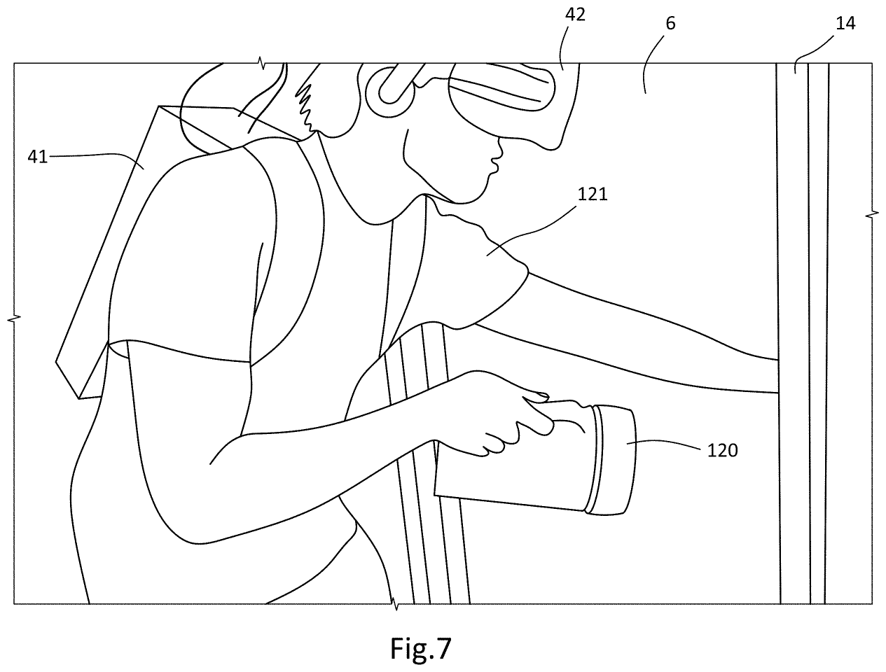

FIG. 7 illustrates a VR participant 121 carrying a backpack 41 and wearing a VR headgear 42. The backpack 41 carries a computer (not shown) running a VR engine. The VR participant 121 is holding a flashlight prop 120 while pushing open the door 6 of the building façade 14. The flashlight prop 120 comprises a conventional flashlight case. To create the flashlight prop 120, any regular-sized battery, and optionally also the light bulb and lens, in the conventional flashlight case are removed. These items are replaced with a smaller power source, orientation sensors and/or a self-tracking beacon so that a motion tracking system (not shown) can determine identification, location, orientation, rotation, movement, and actuation information of the flashlight prop 120.

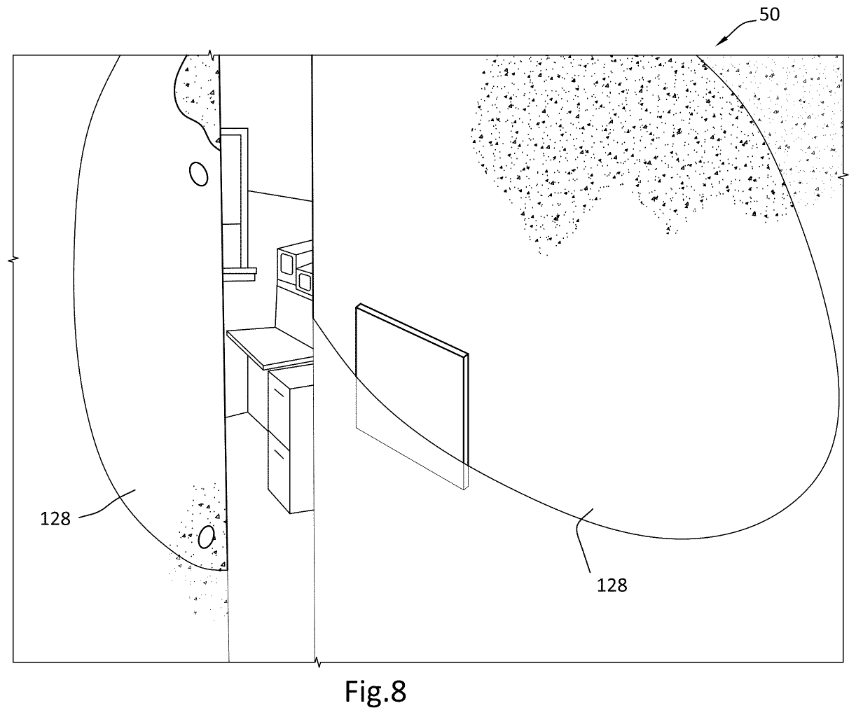

As shown in FIG. 8, a VR engine running on the computer in the backpack 41 receives the identification, location, orientation, rotation, movement, and actuation information of the flashlight prop 120 and renders a VR representation 50 of a flashlight-illuminated portion of the facade 14 and door 6, and a portion of an office beyond the facade 14. In this VR representation 50, which contrasts with the woodsy VR representation 50 of FIG. 6, the doorway is embellished to look aged, with rust spots and paint chips. Elliptical areas 128 are rendered illuminated and the areas around the elliptical areas 128 are rendered dark, corresponding to the direction in which the flashlight prop 120 is pointing. This reinforces the illusion that the sensory information received from the VR headgear 42 is real.

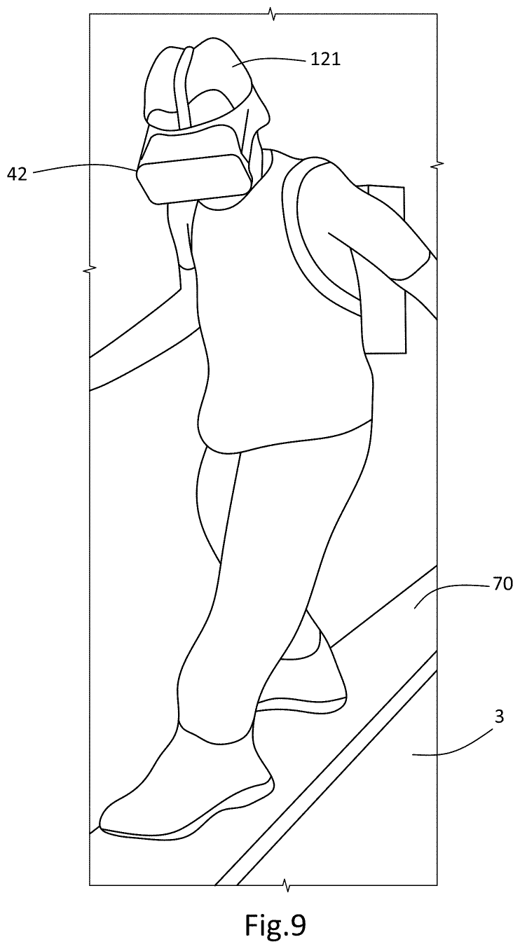

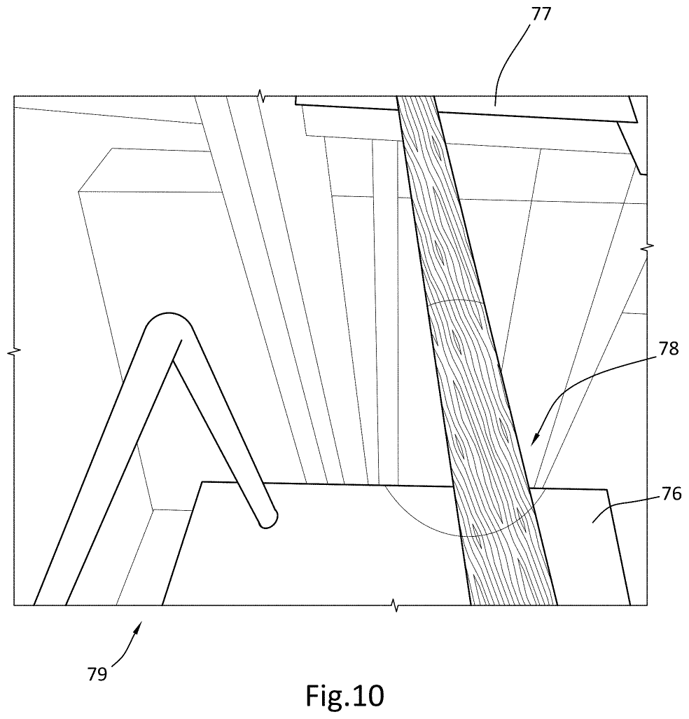

FIG. 9 illustrates the VR participant 121 walking over the wooden plank prop 70 that is shown in FIG. 1 positioned on a modular stage platform 3. The wooden plank prop 70 has a natural warp that causes it to wobble when crossed. The wooden plank prop 70, like the flashlight prop 120, is a moveable smart prop that includes orientation sensors and/or a self-tracking beacon so that a motion tracking system (not shown) can determine identification, location, orientation, rotation, and movement information of the wooden plank prop 70. The VR participant 121 walks very cautiously over the plank 70, even though the plank 70 is safely resting on the platform 3, and the VR participant 121 has a mere 1½ inches to fall should he lose his footing. The VR participant's fear is fueled by the VR representation 50 depicted through the participant's headgear 42. As shown in FIG. 10, the VR participant 121 sees a virtual representation 79 of the plank 70 precariously spanning a deep gap 78 separating two buildings 76 and 77. And when the physical plank 70 wobbles, the motion tracking system employs the identification, location, orientation, rotation, and movement information wirelessly provided from the plank 70 to detect the wobble. Using this information, the VR engine simulates the wobble and the disorienting effect of the wobble on in the VR representation 79 of the plank 70. Sound effects, such as squeaks, wood cracking and splintering further add to the illusion of danger.

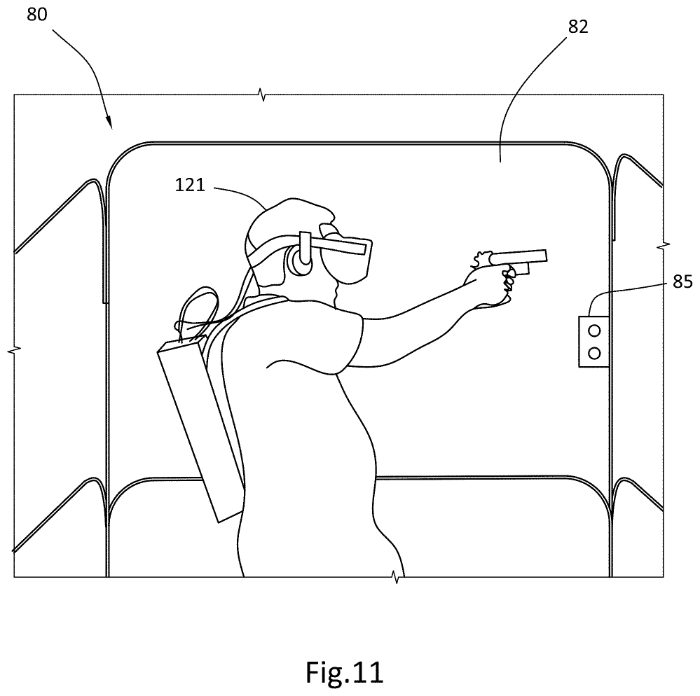

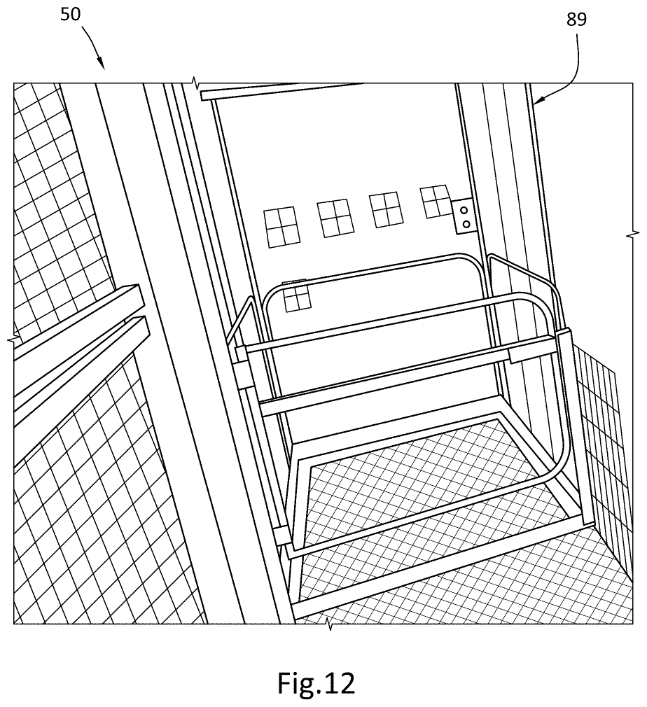

FIG. 11 illustrates the VR participant 121 in one embodiment of an elevator simulator 80 comprising an enclosure 82 made of bars, thatched plates, and/or gates. The simulator 80 may additionally comprise a controller 85 having actuators such as a switch or buttons mounted to the enclosure 82. The elevator simulator 80 is substantially stationary, moving over a span of only a few centimeters or inches to create an illusion of ascending or descending. FIG. 12 illustrates a VR representation 50 of a corresponding VR elevator 89. The VR elevator 89 is shown ascending or descending one or more floors while the corresponding elevator simulator 80 vibrates a platform (not shown) that is coupled to the enclosure 82. The elevator simulator 80 is further described in FIG. 18.

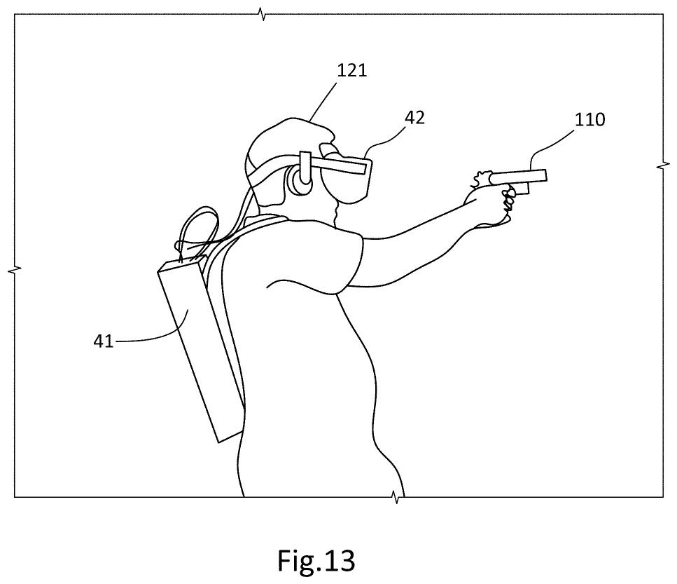

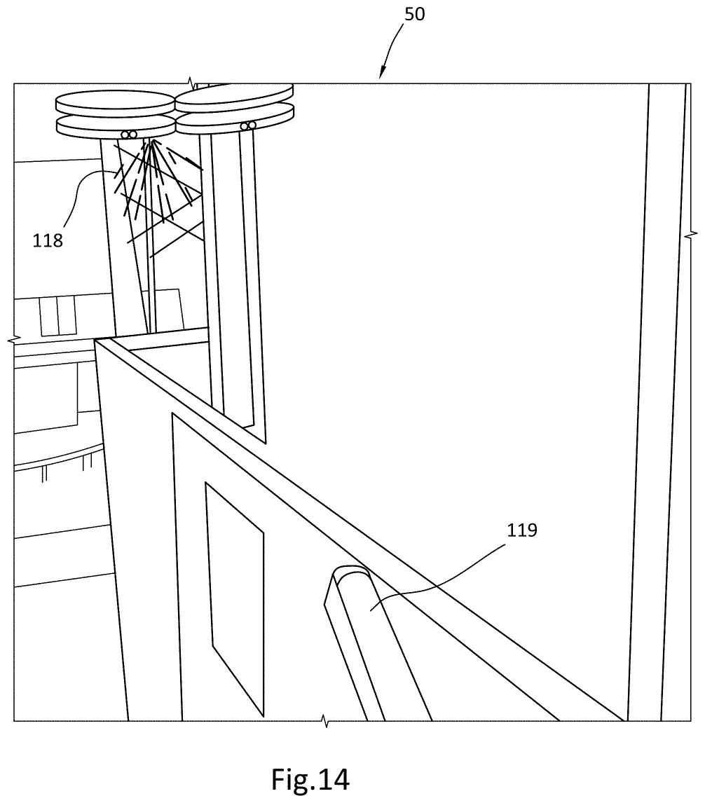

FIG. 13 illustrates the VR participant 121 holding and pointing a firearm prop 110. FIG. 14 illustrates a corresponding VR representation 50 provided to the VR participant 121 as he holds, points, and shoots the firearm prop 110. The VR representation 50 includes a depiction of a VR firearm 119 that is pointed in a direction that corresponds to the direction in which the firearm prop 110 is pointed. The VR representation 50 also depicts kill simulations 118 in response to the VR participant 121 “firing” the firearm 110.

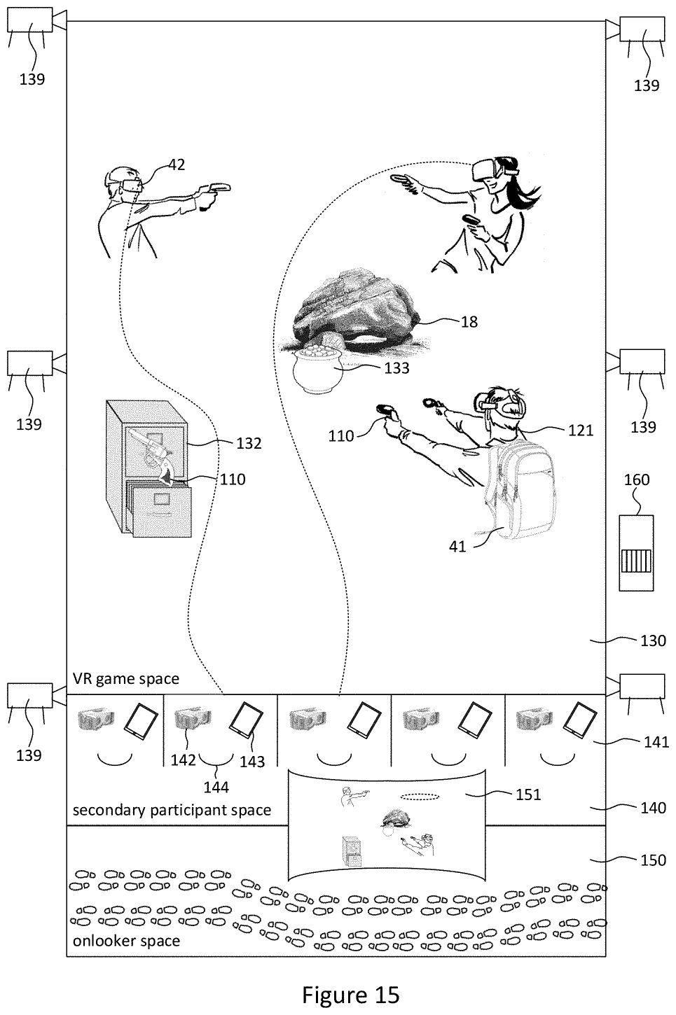

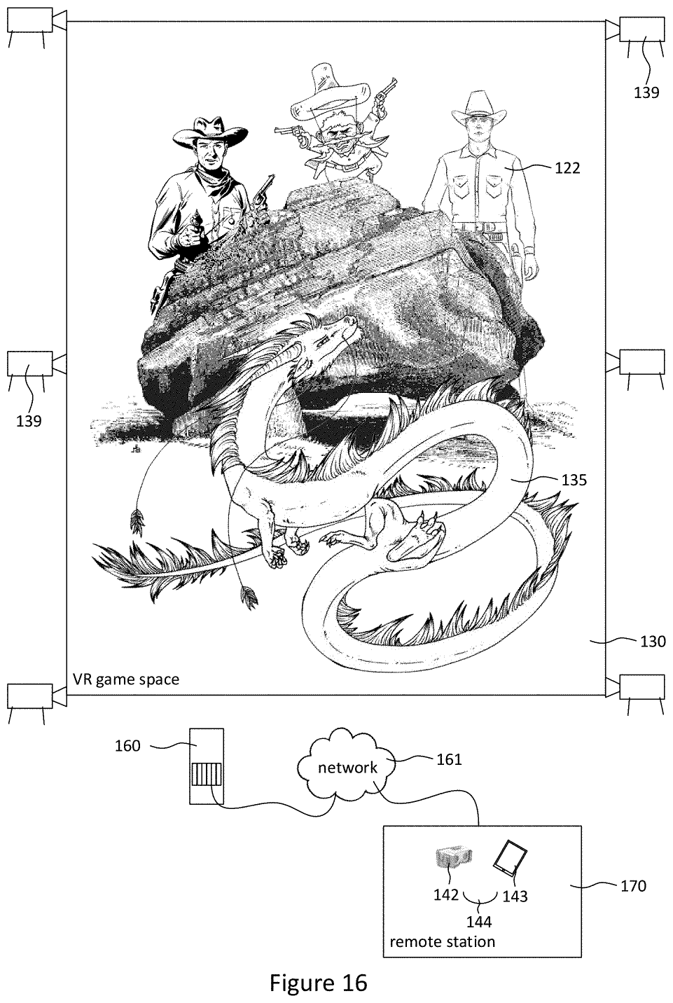

FIG. 15 illustrates a “porous interaction” system in which secondary spectators and/or participants experience and/or participate in the VR world experienced by the players 121. The system comprises a game space 130 (such as the modular stage platform 3 of FIG. 3A) in which a VR gameplay experience is provided. Multiple players 121 physically ambulate on the game space 130 and participate in the shared VR gameplay experience. In this illustration, each player 121 holds two gun props 110. A plurality of other props—including a filing cabinet 132, another gun prop 110, a boulder prop 18, and a pot-of-gold prop 133—are staged in the game space 130. Each player 121 is also represented in the VR world by an avatar (FIG. 16) that mimics the body positions and movements (e.g., standing, sitting, walking, squatting, handling a prop) of the player 121. The VR world depicts each avatar in place of the corresponding player 121.

The game space 130 is intensively monitored by a motion tracking system. The motion tracking system comprises a plurality of cameras 139, light detectors, and/or laser range finders arranged along the perimeter of the game space 130 and/or over the game space 130. The motion tracking system streams tracking data to a VR server 160, which assembles a data structure describing the position and orientation of all persons and movable objects in the game space 130. The VR server 160 feeds its data structure (more generally, constructs of a simulated VR world) to VR engines carried in the players' backpacks 41. Each VR engine integrates the data structure, the avatars, and the virtual objects representing movable objects into a final 3D representation of the VR world from the unique perspective of the player 121 carrying the VR engine. This final 3D representation of the VR world is fed into VR headsets 42 worn by the players 121.

The physical props are represented in virtual form in the VR world. The virtual representations of the physical props are spatially aligned with the physical props in the game space 130. The physical props provide a tactile formation—a real-world substrate—to enhance virtual audio and visual representations of the physical props in the VR world.

FIG. 15 also illustrates a secondary participant space 140 set apart from and adjacent to the game space 130. In one implementation, the secondary participant space 140 comprises pay booths 141 to generate revenue from friends, family members, acquaintances and/or strangers sharing in a player's VR gameplay experience either actively or inactively. In this manner, revenue is generated not only from players 121 playing within the game space 130, but also non-players who are willing to pay to share in a player's VR experience.

The secondary participant space 140 is equipped with one or more feeds from the VR server 160 into the secondary participant space 140 to enable secondary participants to see and hear the VR world that is also presented to players 121. The one or more feeds going from the VR server 160 to the secondary participant space 140 provide visual and audio experiences from one or more players' perspectives, so that a secondary participant can share in the video and audio that a player 121 experiences from the vantage of the player 121. The audio feeds provide both sounds produced for players 121 in the VR world and sounds produced by the players 121 themselves. VR equipment (e.g., VR headsets 142 or VR visual display sets such as TVs, computer monitors, and entertainment centers) are provided to secondary participants to use to visualize and hear the VR world. The booths 141 may be furnished with chairs 144 and/or other furnishings to enhance the experience.

In one implementation involving audio interaction, the secondary participant space 140 is also equipped with one or more audio feeds from the secondary participant space 140 to the VR server 160, so that non-players can communicate with players 121, and the one or more players 121 can hear words and sounds expressed by one or more of the secondary participants. These in-going audio feeds are distinguished from the out-going VR world audio feeds.

In another implementation involving data interaction, the secondary participants are equipped with controllers 143 that transfer input commands to the VR server 160, or text input devices that transfer text commands to the VR server 160, and the VR server 160 responds to these commands by altering an environ and/or gameplay in the VR world. The controllers 143 enable the secondary participants to collectively (e.g., democratically or anarchically, as in Twitch) alter an aspect of the virtual world (e.g., a path or the introduction of a virtual defender or attacker). In a further development, the controllers 143 give the secondary participants an option and interactive area 186 to pay for a power-up for a player 121, wherein power-ups are objects that instantly benefit or add extra abilities to game characters of the players 121. For example, a power-up may be a play gun (e.g., foam dart gun, foam ball gun) that shoots a harmless projectile that is unable to penetrate human skin on the one or more players 121. To further illustrate, the first power-up may be initially locked inside an inaccessible space and released when the first power-up is paid for. Also, play guns may be disabled if the player 121 shooting and the player 121 being shot at are too close to each other.

FIG. 15 also illustrates an onlooker space 150 set apart from both the game space 130 and the secondary participant space 140. A 2D video digital feed to a display 151, visible to the onlookers, provides the onlookers with a 2D representation of gameplay occurring within the game space 130. Preferably, the 2D video digital feed switches between showing one player's perspective and showing one or more other players' perspectives and presenting promotions of the game and other products and services.

In one implementation, an onlooker audio digital feed is provided from the onlooker space to the VR server 160. The onlooker audio digital feed incorporates the audio digital feed into ambient sound heard by the one or more players 121.

FIG. 16 illustrates another implementation—similar to that of the previous figure—of a multi-player VR system. As with the previous figure, FIG. 16's VR system provides a VR game space 130 for a plurality of players 121 to move about and play a multi-player VR game while experiencing visual and audio sensations of a VR world. Unlike the previous figure, FIG. 16 depicts avatars of three players 121, showing them in different positions than the players 121 shown in the previous figure. The players 121 have gunslinger avatars 122 and are situated behind a large rock prop 18. A VR dragon character 135, which does not take the form of a game space player 121, is situated on the other side of the rock 18, preparing to strike.

One or more VR processors (including a VR server 160) construct for each player 121 a unique perspective (from the player's vantage) of the VR world. The one or more VR processors digitally feed the players' VR world representations to corresponding players 121. The VR server 160 feeds one or more of the players' VR world representations through a network interface onto a network 161 and to a remote station 170 or web interface 180.

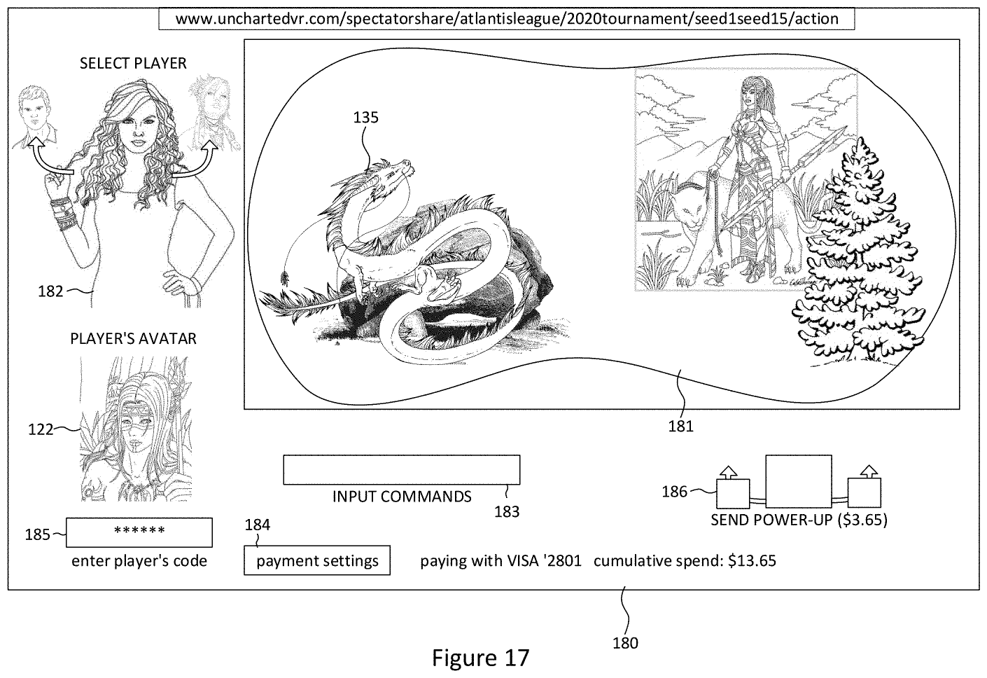

FIG. 17 illustrates a web interface 180 for the system that enables remote viewers to select players 121, see their avatars 122, access the players' corresponding VR world representations 181, and visualize and hear the VR world from the vantage of the selected player 121. In one implementation, the remote viewer visualizes the VR world through a window on a computer monitor, a phone, a laptop, a tablet, or another digital interactive communication device 143. In another implementation, the remote viewer has a VR headset, VR glasses, VR goggles, or equivalent VR headgear 142, giving the remote viewer the same 3D rendition of the VR world that the selected player 121 sees.

As with FIG. 16, the players 121 conduct their game play in a game space 130. In a typical embodiment, physical props are staged in the game space 130. In the simulated VR world, the physical props are represented in virtual form. The virtual representations of the physical props are spatially aligned with the physical props in the game space 130. And the physical props provide a tactile, real-world substrate to enhance virtual audio and visual representations of corresponding virtual objects in the VR world. Each player 121 is represented in the VR world by an avatar, wherein the avatar mimics the body positions and movements of the player 121, and wherein the VR world illustrates each avatar in place of the corresponding player 121.

In one embodiment, the web interface enables the remote viewer to scroll through player photographs 182 to select a player 121. For instance, the scrolling may take a form resembling rotating a carousel containing the players' photographs. The avatar 122 selected by the player 121 is displayed below the player's photograph 182. In one implementation, only the name of a player 121 is presented, rather than a photograph 182, until the remote viewer enters an access code (e.g., a number, a passphrase, an alphanumeric combination, or a combination of numbers, upper and lower case letters, and special characters) for the player 121.

In one embodiment, the web interface gives remote viewers a field 183 to input keyboard, mouse, trackpad, or text commands to potentially alter the course of play. The VR server 160 is configured to receive a command from the remote viewer and to respond to the command by altering an environ and/or gameplay in the VR world.

In another embodiment, the web interface gives the remote viewer an option and an interactive area 186 (e.g., button controls or an equivalent) to purchase power-ups for a player 121 and to bill the remote viewer immediately after each purchase. As noted earlier, power-ups are objects that instantly benefit or add extra abilities to game characters of the players 121. The system, with or without the aid of third-party payment systems, bills the online participant immediately after each purchase.

The web interface includes a pay interface 184 that enables the viewer to pay to select the player 121 and access the player's VR world representation. The pay interface may utilize an interface of third-party online payments system, such as PayPal®, that services online money transfers. In one implementation, the web interface notifies the player 121 of the selected payment method and the cumulative amount that the remote viewer has spent.

The web interface also provides one of many conventional login interfaces 185 to screen remote viewers. A player 121 has at least one code which a remote viewer must enter to share in the player's VR experience. The player 121 may have more than one code, each code distinguished by the amount of interactivity enabled for the remote viewer. For example, a player 121 can provide a general access code to enable persons to share in the player's VR experience, but not to interfere with or interact with the player's VR experience. At the same time, the player 121 can provide a special access code to enable a trusted friend to interact with the player's VR experience by providing words of advice or encouragement to the player 121 during game play and/or by providing the player 121 with power-ups.

Another implementation makes the VR experience more interactive by incorporating sounds spoken or produced by the remote viewer in the audio feed received by the player 121. The VR server 160 is configured to receive remote participant audio from the remote viewer, and the one or more processors integrate the remote participant audio into the selected player's VR world representation. To prevent the remote participant from hearing his or her own voice in a delayed feedback loop, the VR server 160 removes remote participant audio from the selected player's VR world representation 181 before feeding it onto a network to the remote viewer.

The invention can also be characterized as a method of sharing multi-player VR entertainment with remote viewers. A VR game space 130 is secured (e.g., acquired, obtained, constructed, set apart, purchased, leased, borrowed, possessed, and/or occupied) that enables a plurality of players 121 to move about and play a multi-player VR game while experiencing visual and audio sensations of a VR world. A plurality of players 121 are equipped with VR equipment that feeds 3D video and audio from the VR world into the players' eyes and ears. One or more VR processors, including a VR server 160, are configured to construct for each player 121, and from the player's vantage, a unique perspective of the VR world. The player's unique perspective of the world is digitally fed to VR equipment worn by the player 121. A remote online participant, who is located at least 100 meters from the VR game space 130, uses a web interface 180 to select a player 121 to obtain a video and audio feed of the player's unique perspective of the VR world. The remote online participant visualizes and hears the player's unique VR world representation 181.

In one embodiment meant to discourage trolls, players 121 are given a code or directed to create a code that can be used by remote online participants to obtain the video and audio feed of the player's unique perspective of the VR world. The system prevents online participants from successfully selecting a player 121 unless the online participant enters the code given to or received from the selected player 121.

In another embodiment, the remote online participants enter commands into a command interface 183 to alter an aspect of the virtual world. The commands issued by the online participant may be to control a virtual character (such as a dragon 135), other than one of the players 121, in the VR world. The virtual character may be a friend to the player 121 or a foe of the player 121, for example, the serpent dragon 135 of FIG. 17.

Other embodiments combine elements of FIGS. 15-17. For example, one embodiment includes both FIG. 15's secondary participant and onlooker spaces and FIG. 17's web interface for remote viewers. In another embodiment, aspects of FIG. 17's web interface are provided to secondary participants in the secondary participant space 140 or in booths or partitions of the secondary participant space 140.

A typical computer system (not shown) for use with the present invention will contain at least one computer, and more likely multiple networked computers, each having a CPU, memory, hard disk, and various input and output devices. A display device, such as a monitor or digital display, may provide visual prompting and feedback to VR participants 121 and a stage operator during presentation of a VR representation. Speakers or a pair of headphones or earbuds provide auditory prompting and feedback to the subject.

A computer network (not shown) for use with the present invention may connect multiple computers to a server and can be made via a local area network (LAN), a wide area network (WAN), via Ethernet connections, directly or through the Internet, or through Bluetooth or other protocols.

Those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A multi-player virtual reality (VR) system comprising:
a game space in which multiple players physically ambulate and participate in a shared VR gameplay experience;
VR headgear worn by the players;
a VR server that serves one or more constructs of the simulated VR world to VR engines that digitally feed the players' VR headgear; and
a secondary participant space set apart from the game space, wherein the secondary participant space is equipped with one or more feeds from the VR server into the secondary participant space to enable secondary participants to see and hear a VR world that is being presented to the players.

2. The system of claim 1, further comprising physical props staged in the game space and a simulated VR world wherein:
the physical props are represented in virtual form in the VR world;
the virtual representations of the physical props are spatially aligned with the physical props in the game space;
the physical props provide a real-world tactile formation to enhance virtual audio and visual representations of corresponding virtual objects in the VR world; and
each player is represented in the VR world by an avatar.

3. The system of claim 1, wherein:
the secondary participant space includes VR equipment for secondary participants to visualize and hear the VR world.

4. The system of claim 3, wherein:
the one or more feeds from the VR server into the secondary participant space are configured to provide sights and sounds from the VR world from vantages that match sights and sounds and vantages that the one or more players see and hear through their headgear.

5. The system of claim 1, wherein:
the secondary participant space is equipped with one or more audio feeds from the secondary participant space to the VR server, so that the one or more players can hear words and sounds expressed by one or more of the secondary participants.

6. The system of claim 1, wherein:
the secondary participants are equipped with controllers that transfer input commands to the VR server; and
the VR server responds to the input commands by altering gameplay in the VR game space and/or a perceptible real or virtual aspect of the VR world.

7. The system of claim 6, wherein:
the controllers give the secondary participants an option to purchase power-ups for players, wherein the power-ups are objects that instantly benefit or add extra abilities to game characters of the players.

8. The system of claim 1, wherein the secondary participant space:
comprises partitions that secondary participants can rent in order to share in one or more of the players' VR gameplay, enabling revenue to be generated from not only the one or more players playing within the game space, but also secondary participants sharing in the one or more players' VR gameplay experience; and
provides 3D glasses or VR headgear to enable the secondary participants to see the 3D imagery that the one or more players see in the VR game space and from vantages of the one or more players.

10. The system of claim 1, further comprising:
an onlooker space set apart from both the game space and the secondary participant space; and
a 2D video digital feed to a display, visible to the onlookers, providing the onlookers with a 2D representation of gameplay occurring within the game space.

11. A method of sharing multi-player VR entertainment with remote viewers, the method comprising:
securing a game space in which to provide the multi-player VR entertainment;
equipping a plurality of players with VR headgear that feeds 3D video and audio from a VR world into the players' eyes and ears;
setting up a VR server to serve a construct of the simulated VR world to VR engines that digital feed the players' VR headgear;
setting a secondary participant space apart from the game space, wherein the secondary participant space is equipped with one or more feeds from the VR server into the secondary participant space that enable the secondary participants to passively see and hear the VR world that is being presented to the players.

12. The method of claim 11, wherein each player has a unique spatial perspective of the VR world, further comprising:
equipping the secondary participant space with VR equipment that enables each of the secondary participants to select one of the plurality of players and visualize and hear a 3D representation of the VR world from the unique spatial VR perspective of the selected player.

13. The method of claim 11, further comprising:
equipping the secondary participants with controllers that transfer input commands to the VR server, or text input devices that transfer text commands to the VR server; and
the VR server responding to the input commands or text commands by altering aspects of the VR world and/or gameplay in the VR game space.

14. The method of claim 13, further comprising:
giving the secondary participants an option to pay for a power-up for a player, wherein power-ups are objects that instantly benefit or add extra abilities to game characters of the players.

15. The method of claim 11, further comprising generating revenue from:
the players playing within the game space; and
the secondary participants sharing in one or more of the players' VR gameplay experiences.

16. The method of claim 11, further comprising:
setting apart an onlooker space from both the game space and the secondary participant space; and
providing the onlookers with a 2D representation of gameplay occurring within the game space along with promotions to the onlookers.

17. A multi-player virtual reality (VR) system comprising:
a game space in which multiple players physically ambulate and participate in a shared VR gameplay experience;
VR headgear worn by the players;
one or more VR processors, including a VR server, that construct for each player, and from the player's vantage, a unique perspective of the VR world, which is digitally fed to the player's VR headgear;
a network interface by which the VR server feeds one or more of the players' VR world representations onto a network; and
a web interface through which a remote viewer can select a player, access the player's VR world representation, and visualize and hear the VR world from the vantage of the selected player.

18. The system of claim 17, further comprising physical props staged in the game space and a simulated VR world wherein:
the physical props are represented in virtual form in the VR world;
the virtual representations of the physical props are spatially aligned with the physical props in the game space;
the physical props provide a real-world tactile formation to enhance virtual audio and visual representations of corresponding virtual objects in the VR world; and
each player is represented in the VR world by an avatar, wherein the avatar mimics the body positions and movements of the player, and wherein the VR world illustrates each avatar in place of the corresponding player.

19. The system of claim 17, wherein:
the web interface gives the remote viewer an option to purchase power-ups for a player and to automatically bill the remote viewer for each purchase, wherein power-ups are objects that instantly benefit or add extra abilities to game characters of the players.

20. The system of claim 17, wherein the VR server is configured to receive a command from the remote viewer and to respond to the command by altering an environ and/or gameplay in the VR world.
